(19) United States
(12) Patent Application Publication
(10) Pub. No.: US 2026/0237564 A1
(43) Pub. Date: Aug. 13, 2026

(54) MULTILAYER ELECTRONIC COMPONENT

(71) Applicant: Murata Manufacturing Co., Ltd., Nagaokakyo-shi (JP)

(72) Inventor: Naoki MIKATA, Nagaokakyo-shi (JP)

(21) Appl. No.: 19/636,030

(22) Filed: Apr. 1, 2026

Related U.S. Application Data
(63) Continuation of application No. PCT/JP2025/002544, filed on Jan. 28, 2025.

(30) Foreign Application Priority Data
Feb. 6, 2024 (JP) 2024-016271

(51) Int. Cl. H01G 4/232; H01G 2/06; H01G 4/008; H01G 4/012; H01G 4/30

(52) U.S. Cl. CPC H01G 4/2325; H01G 2/065; H01G 4/008; H01G 4/012; H01G 4/30

(57) ABSTRACT

A multilayer electronic component includes a laminate including a first surface and a second surface opposite to each other in a lamination direction, a third surface and a fourth surface opposite to each other in a first direction intersecting the lamination direction, and a fifth surface and a sixth surface opposite to each other in a second direction intersecting the lamination direction and the first direction. The multilayer electronic component also includes external electrodes respectively provided on the third surface and the fourth surface of the laminate. The external electrodes include a primary electrode layer and a plated layer. Glossiness of an outermost surface of the plated layer is about 63% or greater.

### CROSS REFERENCE TO RELATED APPLICATIONS

This application claims the benefit of priority to Japanese Patent Application No. 2024-016271 filed on Feb. 6, 2024 and is a Continuation Application of PCT Application No. PCT/JP2025/002544 filed on Jan. 28, 2025. The entire contents of each application are hereby incorporated herein by reference.

### BACKGROUND OF THE INVENTION

### 1. Field of the Invention

The present invention relates to multilayer electronic components.

### 2. Description of the Related Art

In many cases, a multilayer electronic component is mounted on a substrate with solder. However, the multilayer electronic component may be adversely affected by flux included in the solder. Thus, the multilayer electronic component may be mounted by wire bonding (for example, see Japanese Unexamined Utility Model Registration Application Publication No. 5-4451).

### SUMMARY OF THE INVENTION

When an external electrode of the multilayer electronic component is formed of conductive paste by a dipping method, the center of the external electrode is likely to be rounded due to surface tension of the conductive paste. When the center of the external electrode is rounded, a contact area between the tip of a capillary used for wire bonding and the surface of the external electrode reduces. Thus, favorable connectivity between the external electrode and the wire is unlikely to be ensured.

Furthermore, when the conductive paste is sintered, the surface of the external electrode may be corrugated due to the effect of the glass component or the like included in the conductive paste. As a result, in an ultrasonic process during the wire bonding, favorable connectivity is not necessarily ensured between the wire and the external electrode.

Furthermore, to perform the wire bonding, first, it is necessary to identify the position of the external electrode of the multilayer electronic component by performing image processing. When the position of the external electrode of the multilayer electronic component cannot be identified in an image processing step, the wire bonding cannot be performed.

Example embodiments of the present invention provide multilayer electronic components in each of which a reliability of wire bonding performed on an external electrode is improved.

According to an example embodiment of the present invention, a multilayer electronic component includes a laminate including a first surface and a second surface opposite to each other in a lamination direction, a third surface and a fourth surface opposite to each other in a first direction intersecting the lamination direction, and a fifth surface and a sixth surface opposite to each other in a second direction intersecting the lamination direction and the first direction. The multilayer electronic component also includes external electrodes respectively provided on the third surface and the fourth surface of the laminate. The external electrodes include a primary electrode layer and a plated layer. Glossiness of an outermost surface of the plated layer is about 63% or greater.

To address the above-described problem, according to another example embodiment of the present invention, a multilayer electronic component includes a laminate including a first surface and a second surface opposite to each other in a lamination direction, a third surface and a fourth surface opposite to each other in a first direction intersecting the lamination direction, and a fifth surface and a sixth surface opposite to each other in a second direction intersecting the lamination direction and the first direction. The multilayer electronic component also includes external electrodes respectively provided on the third surface and the fourth surface of the laminate. The external electrodes include a primary electrode layer and a plated layer. Linearity of the primary electrode layer is about 1.21 or smaller.

According to example embodiments of the present invention, multilayer electronic components in each of which the reliability of the wire bonding performed on the external electrode is improved during the wire bonding are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a sectional view of the multilayer ceramic capacitor 1 illustrated in FIG. 1 taken along line II-II of FIG. 1, illustrating a state in which the multilayer ceramic capacitor 1 is mounted on a substrate 100 and connected with wire bonding.

FIG. 3 illustrates linearity by enlarging part of a primary electrode layer 3a of FIG. 2.

FIG. 4 is a flowchart illustrating a method for manufacturing the multilayer ceramic capacitor 1.

FIGS. 5A and 5B illustrate a wire bonding method.

FIG. 6 is a table indicating evaluation result 1 about an image recognition property of the multilayer ceramic capacitor 1.

FIG. 7 is a table indicating evaluation result 2 evaluating the connectivity between a wire and an external electrode in the multilayer ceramic capacitor 1.

FIG. 8 illustrates a state in which a multilayer ceramic capacitor 1A according to another example embodiment of the present invention is mounted on the substrate 100.

### DETAILED DESCRIPTION OF THE EXAMPLE EMBODIMENTS

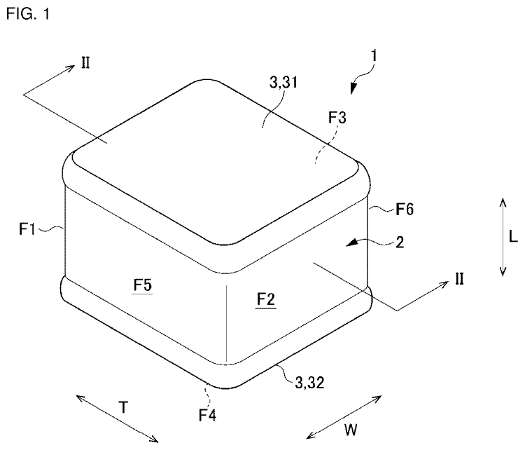

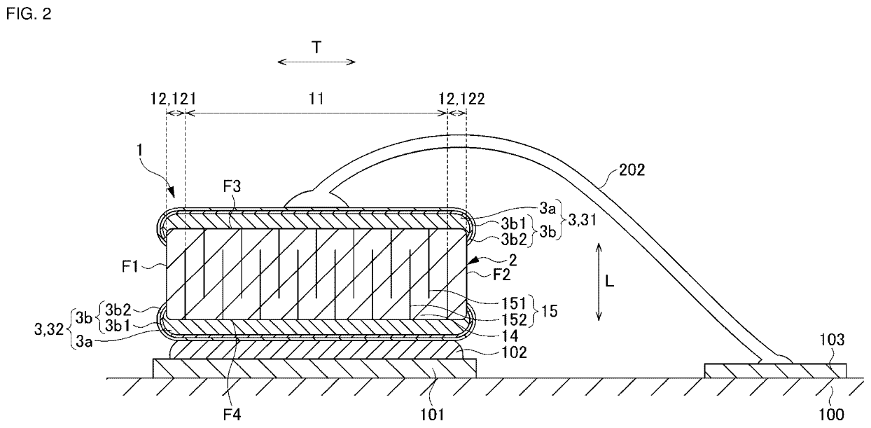

Hereinafter, multilayer ceramic capacitors according to example embodiments of the present invention are described. FIG. 1 is a schematic perspective view of a multilayer ceramic capacitor 1 according to a present example embodiment. FIG. 2 is a sectional view of the multilayer ceramic capacitor 1 illustrated in FIG. 1 taken along line II-II of FIG. 1, illustrating a state in which the multilayer ceramic capacitor 1 is mounted on a substrate 100 and connected with wire bonding.

The multilayer ceramic capacitor 1 includes a laminate 2 and a pair of external electrodes 3 respectively provided on a third surface F3 and a fourth surface F4 being two surfaces of the laminate 2 opposite to each other.

In the following description, as the terms representing the directions of the multilayer ceramic capacitor 1, a direction in which dielectric layers 14 and internal electrode layers 15 are laminated is defined as a lamination direction T. In the multilayer ceramic capacitor 1, a direction which intersects the lamination direction T and in which the pair of external electrodes 3 are provided is defined as a first direction L. A direction which intersects both of the first direction L and the lamination direction T is defined as a second direction W. According to the present example embodiment, the lamination direction T, the first direction L, and the second direction W are perpendicular to each other.

In the multilayer ceramic capacitor 1 according to the present example embodiment, the dimension is greater in the lamination direction T than in the first direction L. As illustrated in FIG. 2, a second external electrode 32 on the fourth surface F4 side of the multilayer ceramic capacitor 1 is attached to a first land 101 provided on one surface of the substrate 100 with solder 102.

The laminate 2 includes an inner layer portion 11 and two outer layer portions 12 disposed such that the inner layer portion 11 is interposed between the outer layer portions 12 from both sides of the lamination direction T. The inner layer portion 11 includes a plurality of pairs of dielectric layers 14 and internal electrode layers 15.

Herein, six outer surfaces of the laminate 2 illustrated in FIG. 1 include a pair of outer surfaces opposite to each other in the lamination direction T are a first surface F1 and a second surface F2, respectively, a pair of outer surfaces opposite to each other in the first direction L are a third surface F3 and a fourth surface F4, respectively, and a pair of outer surfaces opposite to each other in the second direction W are a fifth surface F5 and a sixth surface F6, respectively. The surface of the laminate 2 may be roughened.

Portions where two surfaces out of the first surface F1, the second surface F2, the third surface F3, the fourth surface F4, the fifth surface F5, and the sixth surface F6 intersect are referred to as edge portions, and portions where three surfaces out of these surfaces intersect are referred to as corner portions. Preferably, the edge portions and corner portions are rounded. When the edge portions and corner portions are rounded, chipping and cracking in the edge portions and the corner portions can be prevented. When the edge portions and corner portions are rounded, surfaces excluding the edge portions and the corner portions may be flat.

The inner layer portion 11 includes first internal electrode layers 151, second internal electrode layers 152, and the dielectric layers 14. One end of each of the first internal electrode layers 151 is exposed at the third surface F3. One end of each of the second internal electrode layers 152 is exposed at the fourth surface F4. The dielectric layers 14 are alternately laminated on the first internal electrode layers 151 and the second internal electrode layers 152.

The dielectric layers 14 each include a first region and a second region. The first region covers one end of the first internal electrode layer 151 in the first direction L not exposed at the third surface F3 or the one end of the second internal electrode layer 152 in the first direction L not exposed at the fourth surface F4. The second region covers at least a portion of one of the surfaces of the first internal electrode layer 151 in the lamination direction T and at least a portion of one of the surfaces of the second internal electrode layer 152 in the lamination direction T.

That is, the first region means a region between the first internal electrode layer 151 and the fourth surface F4 and a region between the second internal electrode layer 152 and the third surface F3. The second region covers at least a portion of the surface of the first internal electrode layer 151 on the first surface F1 side and at least a portion of the surface of the second internal electrode layer 152 on the first surface F1 side.

A dielectric component included in the greatest amount in the first region and a dielectric component included in the greatest amount in the second region are preferably of the same type. The dielectric component may include components such as, for example, Ba, Ti, Ca, Zr, and Sr, but is not limited to these. For example, when a great amount of CaTiO₃ or CaZrO₃ is included as the dielectric component, dielectric breakdown occurring between the end portion of the first internal electrode layer 151 in the first direction L and the second external electrode 32, and between the first internal electrode layer 151 and the second internal electrode layer 152, can be reduced or prevented. The main component is not limited to these and may be SrTiO₃ or the like.

Furthermore, the second region is preferably formed of a material having a high dielectric constant such as, for example, BaTiO₃, to increase the capacitance of the multilayer ceramic capacitor 1.

The internal electrode layers 15 include a facing region where the first internal electrode layers 151 and the second internal electrode layers 152 face each other and extension regions extending from the facing region to portions on the third surface F3 and portions on the fourth surface F4. Furthermore, the internal electrode layers 15 may have a width that varies toward exposed ends of the internal electrode on one side.

The component of the first internal electrode layers 151 and the second internal electrode layers 152 can include an appropriate conducting material such as, for example, Ni, Cu, Ag, Pd, Au, SN or other types of metal or an alloy such as an Ag—Pd alloy including at least one of such types of metal. However, this is not limiting. When Sn is included in the first internal electrode layers 151 and the second internal electrode layers 152, concentration of electric fields in interfaces can be reduced. This leads to improvement of reliability under a high-temperature load. At this time, such an effect can be sufficiently produced even when Sn is included in only one type of the internal electrode layers 15, that is, included in either the first internal electrode layers 151 or the second internal electrode layers 152.

When a region between the first internal electrode layers 151 and the fifth surface F5 and between the second internal electrode layers 152 and the fifth surface F5 is defined as a fifth surface side region, and region between the first internal electrode layers 151 and the sixth surface F6 and between the second internal electrode layers 152 and the sixth surface F6 is defined as a sixth surface side region, segregation of Si may exist in the fifth surface side region and the sixth surface side region provided on respective sides of the internal electrode layers 15 in the second direction W. This can improve flexural strength of the multilayer ceramic capacitor 1.

The outer layer portions 12 include a first outer layer portion 121 and a second outer layer portion 122. The first outer layer portion 121 and the second outer layer portion 122 are formed of respective insulating materials. When the outer layer portions 12 are formed of dielectric materials that are of the same types as those of the first region and the second region of the dielectric layers 14, the outer layer portions 12 may include a plurality of outer-layer dielectric layers or a single outer-layer dielectric layer. The dielectric layers 14 and the outer layer portions 12 may include different components. For example, the dielectric layers 14 can have a higher dielectric constant than that of the outer layer portions 12, and the component of the outer layer portions 12 can be changed into a component having a satisfactory moisture resistance, a satisfactory weather resistance, or satisfactory strength. Furthermore, the outer layer portions 12 may be formed of a diamond-like carbon (DLC) film or a different-type insulating material such as an insulating resin.

The external electrodes 3 include a first external electrode 31 disposed on the third surface F3 and the second external electrode 32 disposed on the fourth surface F4. The external electrodes 3 are preferably disposed so as to extend to the first surface F1, the second surface F2, the fifth surface F5, and the sixth surface F6. Each of the first external electrode 31 and the second external electrode 32 includes a primary electrode layer 3a and a plated layer 3b.

According to the present example embodiment 1, the primary electrode layer 3a includes a metal component and a glass component. Preferably, the main component of the primary electrode layer 3a is Cu. However, the primary electrode layer 3a may include a metal component other than Cu and a glass component. The glass component is, for example, an oxide such as Ba, Sr, Si, Ca, Zn, Al, or B. Examples of the other metal component may include, for example, Mg, Cr, Sr, Al, Na, Fe, and the like.

According to modification 1, the primary electrode layer 3a may includes a metal component and a dielectric component of the same type as that of the dielectric layer 14. In this way, the laminate 2 and the primary electrode layer 3a can be formed by simultaneous firing. This can improve the connectivity between the internal electrode and the primary electrode layer 3a.

According to modification 2, the primary electrode layer 3a may includes a conducting component and a resin component. This can reduce or prevent cracking due to stress releasing operation with resin.

According to modification 3, the primary electrode layer 3a may include a plated layer including 99 or greater volume percent of the metal component. In this case, the plated layer is directly connected to the internal electrode 3.

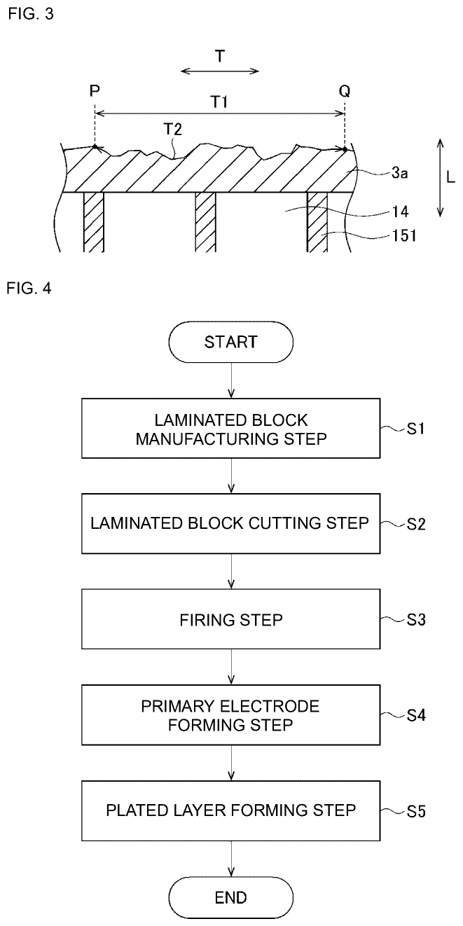

The linearity of the primary electrode layers 3a disposed on the third surface F3 and the fourth surface F4 is preferably about 1.21 or smaller and, more preferably, about 1.11 or smaller, for example. The linearity is defined as follows. FIG. 3 illustrates the linearity by enlarging part of the primary electrode layer 3a of FIG. 2 (the plated layers 3b are not illustrated). When a slant distance between two points P and Q on the surface of the primary electrode layer 3a in a section as illustrated in FIG. 3 is T1, and a distance between the same two points along the shape of the surface of the primary electrode layer 3a is T2, the linearity is defined as T2/T1. A great linearity means a great unevenness of the surface of the primary electrode layer 3a, and a small linearity means small unevenness of the surface of the primary electrode layer 3a.

Specifically, the linearity is obtained as follows.
(1) The multilayer ceramic capacitor 1 is polished to positions respectively at 2/5, 3/5, and 4/5 of W 0 in the second direction W from, for example, the fifth surface F5 side toward the sixth surface F6 side. Here, W0 is the dimension of the multilayer ceramic capacitor 1 in the second direction W. At each of the positions, that is, at three positions being 2/5, 3/5, and 4/5 of W0, an image of the outermost surface of the primary electrode layer 3a is taken in a section of the first direction L by the lamination direction T. The image is taken with a scanning electron microscope (SEM) at 10000-fold magnification.
(2) From the SEM image of the outermost surface of the primary electrode layer 3a having been taken, the length of the outermost surface of the primary electrode layer 3a is calculated by the following expression: “length of perimeter”-“average vertical chord length”×2−“width of image”.
(3) The linearity of the primary electrode layer 3a is defined by “length of outermost surface of primary electrode layer 3a”/“width of image”.
(4) An average of the linearity of the primary electrode layer 3a in three regions, that is, at 2/5, 3/5, and 4/5 of W0 is defined as the linearity of the primary electrode layer 3a.

As described above, the linearity of the primary electrode layers 3a disposed on the third surface F3 and the fourth surface F4 is preferably about 1.21 or smaller and, more preferably, about 1.11 or smaller, for example. When the linearity of the primary electrode layer 3a is about 1.21 or smaller, the linearity of the outermost surface of the external electrode 3 on the primary electrode layer 3a is favorable (small) even after the plated layer 3b is formed on the primary electrode layer 3a. Thus, connectivity between a wire 202 and the external electrode 3 can be improved in performing wire bonding on the external electrode 3.

According to the present example embodiment, preferably, the plated layer 3b disposed outside the primary electrode layer 3a includes at least two layers. The plated layer 3b includes an Au-plated layer 3b2 at an outermost surface. According to the present example embodiment, for example, an Ni-plated layer 3b1 and the Au-plated layer 3b2 disposed in this order from the primary electrode layer 3a side are included. However, the plated layer 3b is not limited to this. The plated layer 3b may have a three-layer structure. In this case, for example, an Ni-plated layer, an Sn-plated layer, and an Au-plated layer may be disposed in this order from the primary electrode layer 3a side. The Ni-plated layer 3b1 can prevent the primary electrode layer 3a from being eroded by solder. When the Au-plated layer 3b2 serves as the outermost surface, properties of Au wire bonding can be improved.

However, the type of the plated layer 3b is not limited to the above description and may be another type. In the case of the other type, for example, at least one type of metal selected from Cu, Ni, Sn, Pb, Au, Ag, Pd, Bi, Zn, and the like or an alloy including such metal is preferably included. Preferably, the plated layer 3b includes no glass. Preferably, the metal content of the plated layer 3b per unit volume is about 99 or greater volume percent, for example.

According to the present example embodiment, the glossiness of an outermost surface of the plated layer 3b is preferably about 63% or greater, and more preferably, about 71% or greater, for example. The glossiness is defined as follows.
(1) An image is taken from the first direction L with, for example, VHX-1000 made by Keyence Corporation so that the entirety of the outermost surface of the plated layer 3b appears in the image.
(2) After that, the entire image of the outermost surface of the plated layer 3b having been taken is binarized into, for example, black and white with ImageJ (trademark). Based on the binarized values having been obtained, the glossiness is defined by {(white area)/(entire area)}×100(%).
(3) As the contrast of ImageJ, for example, when a range of the brightness of the image having been taken is from 0 to N and N/2 is the threshold, it is determined that N/2 or greater is white and smaller than N/2 is black. As an example, when the range of the brightness of the image having been taken is from 0 to 255 and the threshold is 128, it is determined that 128 or greater is white and smaller than 128 is black. At this time, as the light amount (%) of an illumination method, measurement is performed with coaxial lighting of 100% and ring lighting of 0% of VHX-1000 made by Keyence Corporation.

Next, a non-limiting example of a method for manufacturing the multilayer ceramic capacitor 1 according to the present example embodiment is described. FIG. 4 is a flowchart illustrating the method for manufacturing the multilayer ceramic capacitor 1.

Dielectric sheets for the dielectric layers 14 and conductive paste for the internal electrode layers 15 are prepared. The dielectric sheets and the conductive paste for the internal electrode layers 15 include a binder and a solvent. A well-known binder and a well-known solvent may be used.

The conductive paste for the internal electrode layers 15 is printed on the dielectric sheets in predetermined patterns by, for example, screen printing, gravure printing, or the like. Thus, dielectric sheets in which the pattern of the first internal electrode layer 151 is formed and dielectric sheets in which the pattern of the second internal electrode layer 152 is formed are prepared.

Next, when a predetermined number of dielectric sheets on which no pattern of an internal electrode layer is printed are laminated, a portion to become the first outer layer portion 121 is formed on the first surface F1 side. When the dielectric sheets on which the pattern of the first internal electrode layer 151 is printed and the dielectric sheets on which the pattern of the second internal electrode layer 152 is printed are sequentially laminated on the portion to become the first outer layer portion 121, a portion to become the inner layer portion 11 is formed. When a predetermined number of dielectric sheets on which no pattern of the internal electrode layer is printed are laminated on the portion to become the inner layer portion 11, a portion to become the second outer layer portion 122 is formed on the second surface F2 side. In this way, a laminated sheet is produced. Then, when the laminated sheet having been produced is pressed in the lamination direction T using a hydrostatic press or the like, a laminated block is produced.

When the laminated block is cut into pieces of a predetermined size, laminated chips are cut out. At this time, corner portions and edge portions of the laminated chips may be rounded by barrel polishing or the like.

When the laminated chips are fired, the laminates 2 are produced. The firing temperature, which depends on the materials of the dielectric layers 14 or the internal electrode layers 15, is preferably about 900° C. or higher and about 1400° C. or lower, for example. Instead of performing the firing at this time, the laminated chips may be fired together with the primary electrode layers 3a in a primary electrode forming step S4, which will be described below.

The conductive paste is applied to the third surface F3 side and the fourth surface F4 side of the laminate 2, which are to become the primary electrode layers 3a. According to present example embodiment, conductive paste including a glass component and a metal component is applied by a method such as, for example, dipping.

After that, when a baking process is performed, the primary electrode layers 3a are formed. Preferably, the temperature of the baking process at this time is about 700° C. or higher and about 900° C. or lower, for example. In this baking process, when the conductive paste is sintered, the surfaces of the primary electrode layers 3a may be corrugated due to the effect of the glass component or the like included in the conductive paste. The corrugation of the surfaces of the primary electrode layers 3a affects the surface shape of the outermost surfaces of the external electrodes 3, and the shape of the outermost surfaces of the external electrodes 3 becomes corrugated. As a result, during the wire bonding to be described later, when an ultrasonic process is performed to perform wire bonding, favorable connectivity is not necessarily ensured between a wire and an external electrode.

Thus, first, the linearity of the primary electrode layer 3a is improved. The linearity is improved by, for example, using a barrel method or causing cobble stones of zirconia or the like to collide with the surface. In the case of causing the cobble stones to collide with the surface, when the diameter of the cobble stones is excessively large, regions where the cobble stones do not collide are generated in portions of the outermost surface of the primary electrode layer 3a. When the cobble stones collide at an increased speed or increased strength, regions where parts of the primary electrode layer 3a are chipped are generated. Accordingly, the diameter of the cobble stones and the speed at which the cobble stones collide with the surface are appropriately adjusted so as to be adequate for the improvement of linearity.

Alternatively, instead of improving the linearity of the primary electrode layer 3a at this time, the linearity of the primary electrode layer 3a may also be improved after the plated layer 3b has been formed as described below. When the above-described process is performed after the primary electrode layer 3a has been formed, a processing time after a plated layer forming step to be described below can be reduced.

According to the present example embodiment, the plated layers 3b each include the Ni-plated layer 3b1 and the Au-plated layer 3b2 disposed in this order from the primary electrode layer 3a side. The Ni-plated layer 3b1 and the Au-plated layer 3b2 are formed by electrolytic plating performed by, for example, a barrel plating method.

After the Au-plated layer 3b2 has been formed, for example, as is the case with the above-described method of improving the linearity of the primary electrode layer 3a, the barrel method is used or the cobble stones of zirconia or the like are caused to collide with the surface in order to improve the linearity and glossiness of the Au-plated layer 3b2 of the outermost surface of the external electrode 3. In the case of causing the cobble stones to collide with the surface, when the diameter of the cobble stones is excessively large, regions where the cobble stones do not collide are generated in parts of the outermost surface of the Au-plated layer 3b2. When the cobble stones collide at an increased speed or increased strength, regions where parts of the Au-plated layer 3b2 are chipped are generated. Accordingly, the diameter of the cobble stones and the speed at which the cobble stones collide with the surface are appropriately adjusted so as to be adequate for the improvement of linearity. At this time, the linearity of the primary electrode layer 3a is improved. When the above-described process is performed also in the case where the linearity and the glossiness of the outermost surface of the plated layer are low, the glossiness of the Au-plated layer 3b2 being the outermost surface of the plated layer can become about 63% or greater, for example.

By the above-described method for manufacturing, the multilayer ceramic capacitor 1 in which the Au-plated layer 3b2 being the outermost surface of the plated layer has a glossiness of about 63% or greater and the primary electrode layer 3a has a linearity of about 1.21 or smaller, for example, is manufactured.

As illustrated in FIG. 2, the multilayer ceramic capacitor 1 according to the present example embodiment manufactured as described above is joined to the first land 101 provided on the one surface of the substrate 100 such that, for example, the second external electrode 32 on the fourth surface F4 side is joined to the first land with the solder 102.

One end of the wire 202 is connected to the first external electrode 31 on the third surface F3 side of the multilayer ceramic capacitor 1. The other end of the wire 202 is connected to, for example, a second land 103 in the substrate 100 which is other than the first land 101 to which the multilayer ceramic capacitor 1 is joined.

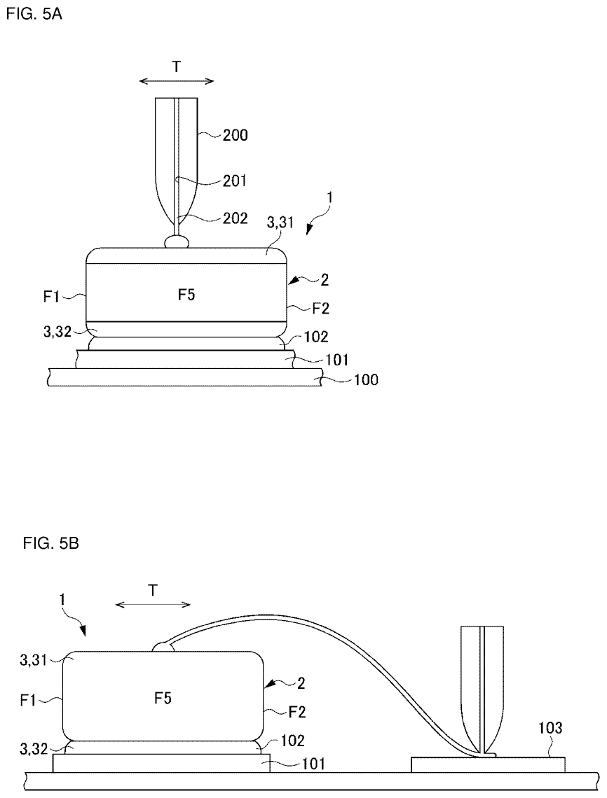

FIGS. 5A and 5B illustrate a wire bonding method. The wire bonding is performed with a bonding device including a capillary 200 having an inner hole 201 (only a capillary 200 portion is illustrated without illustrating the entirety of the device). The wire 202 is inserted through the inner hole 201 of the capillary 200 and can be drawn out from a tip portion of the capillary 200.

According to the present example embodiment, the wire 202 is gold and the outermost surface of the external electrode 3 of the multilayer ceramic capacitor 1 is the Au-plated layer 3b2. Thus, a joining property between the wire 202 and the external electrode 3 is favorable.

First, the bonding device detects the position of the external electrode 3 of the multilayer ceramic capacitor 1 with an image processing mechanism and moves the capillary 200 to a position on the external electrode 3 of the multilayer ceramic capacitor 1 with a movement mechanism.

When the position of the external electrode 3 of the multilayer ceramic capacitor 1 is detected with the image processing mechanism, first, the entirety of the substrate 100 to which the multilayer ceramic capacitor 1 is attached is irradiated with light, and image recognition is performed for the position of the external electrode 3 of the multilayer ceramic capacitor 1 based on the light reflected from the external electrode 3.

At this time, when the glossiness of the outermost surface of the external electrode 3 of the multilayer ceramic capacitor 1 is small, the amount of reflected light is insufficient, and an image recognition property is degraded. As a result, the position of the external electrode 3 cannot be detected, and accordingly, accurate wire bonding cannot be performed.

However, according to the present example embodiment, the glossiness of the plated layer 3b of the outermost surface of the external electrode 3 is about 63% or greater. Accordingly, the external electrode 3 can be favorably recognized from the image having been taken, the likelihood of the erroneous detection of the position of the external electrode 3 can be reduced, and the tip of the capillary 200 can be correctly moved to the position of the external electrode 3.

Next, after the capillary 200 has been moved to a position above the external electrode 3, the tip of the wire 202 is melted by discharging or the like so that the tip of the wire 202 has a ball shape. Then, the capillary 200 is moved down so as to bring the ball at the tip of the wire 202 into pressure contact with the external electrode 3 of the multilayer ceramic capacitor 1 as illustrated in FIG. 5A, and the one end of the wire 202 is connected to an upper portion of the external electrode 3 of the multilayer ceramic capacitor 1 by applying ultrasonic waves or the like.

At this time, when many projections and recesses exist in the outermost surface of the external electrode 3 or the outermost surface is curved, the joining property between the wire 202 and the external electrode 3 degrades. However, the primary electrode layer 3a of the external electrode 3 according to the present example embodiment has the linearity of about 1.21 or smaller, for example. Thus, even after the plated layer 3b has been formed on the external electrode 3, the linearity of the outermost surface of the external electrode 3 is small. That is, the outermost surface of the external electrode 3 has small number of projections and recesses and is not curved. Even if the outermost surface of the external electrode 3 is curved, the degree of curve is small. Accordingly, the wire 202 and the external electrode 3 are favorably joined.

After the one end of the wire 202 is connected to the upper portion of the external electrode 3 of the multilayer ceramic capacitor 1, as illustrated in FIG. 5B, moving to the second land 103 is performed while the wire 202 is drawn out from the inner hole 201 of the capillary 200, and the wire 202 is bonded to the second land 103 by applying ultrasonic vibration while pressing the wire 202 against the second land 103. After that, the wire 202 is cut. Thus, the external electrode 3 of the multilayer ceramic capacitor 1 is connected to the second land 103 on the substrate 100 side.

Next, evaluation result 1 about the image recognition property of the multilayer ceramic capacitor 1 according to the present example embodiment is described.

Five groups of 100 multilayer ceramic capacitors including an Au-plated layer on the outermost surface of the external electrode were prepared. The glossiness values of the Au-plated layer in the five groups are respectively about 39%, about 50%, about 63%, about 71%, and about 79%, for example. The multilayer ceramic capacitors have the following size. The size is common to all the groups of the multilayer ceramic capacitors.
Dimension in first direction L: about 0.4 mm
Dimension in second direction W: about 0.2 mm
Dimension in lamination direction T: about 0.2 mm

Among these multilayer ceramic capacitors, the multilayer ceramic capacitors including the Au-plated layer having the glossiness value of about 63%, about 71%, or about 79% are the multilayer ceramic capacitors 1 according to the present example embodiment. The multilayer ceramic capacitors including the Au-plated layer having the glossiness value of about 39% or about 50% are in comparative forms.

A chip recognition rate and a recognition failure number with the actual bonding device were checked for the groups of 100 multilayer ceramic capacitors having different glossiness values in the comparative forms or the present example embodiment.

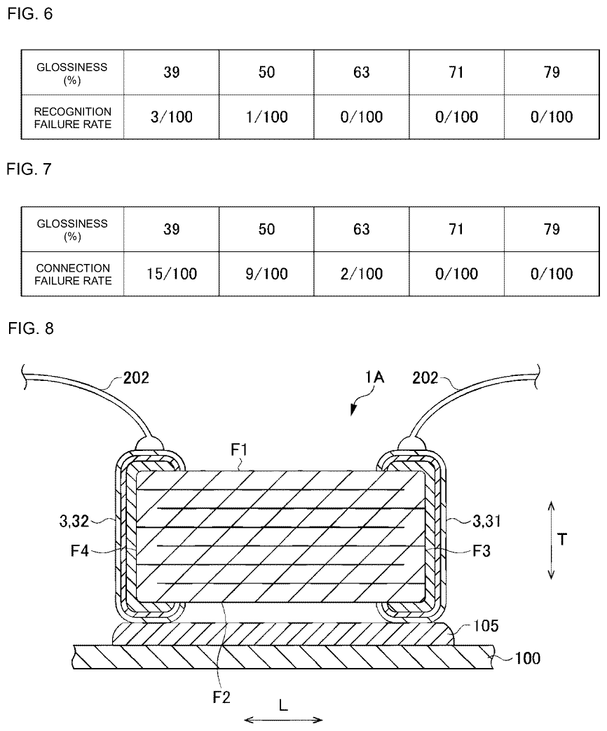

FIG. 6 is a table indicating evaluation result 1 about the image recognition property of the multilayer ceramic capacitor 1. As indicated in FIG. 6, in the case of the multilayer ceramic capacitors in the comparative form having the glossiness value of about 39% that is smaller than about 63%, the recognition failure rate is 3/100, for example. In the case of the multilayer ceramic capacitors in the comparative form having the glossiness value of 50% that is smaller than about 63%, for example, the recognition failure rate is 1/100. In contrast, in the case of the multilayer ceramic capacitors 1 according to example embodiments of the present example embodiment having the glossiness value of about 63% or higher, that is, about 63%, about 71%, or about 79%, for example, the recognition failure rate is 0/100. That is, all the multilayer ceramic capacitors were successfully recognized. Thus, it can be understood that, with the multilayer ceramic capacitor 1 according to the present example embodiment, the image recognition property in the bonding device is high.

Next, evaluation result 2 evaluating the connectivity between the wire and the external electrode in the multilayer ceramic capacitor 1 according to the present example embodiment is described. As is the case with evaluation result 1, five groups of 100 multilayer ceramic capacitors including an Au-plated layer on the outermost surface of the external electrode were prepared. The glossiness values of the Au-plated layer in the five groups are respectively about 39%, about 50%, about 63%, about 71%, and about 79%, for example. The multilayer ceramic capacitors have the following size. The size is common to all the groups of the multilayer ceramic capacitors.
Dimension in first direction L: about 0.4 mm
Dimension in second direction W: about 0.2 mm
Dimension in lamination direction T: about 0.2 mm

Among these multilayer ceramic capacitors, the multilayer ceramic capacitors including the Au-plated layer having the glossiness value of about 63%, about 71%, or about 79% are the multilayer ceramic capacitors 1 according to the present example embodiment. The multilayer ceramic capacitors including the Au-plated layer having the glossiness value of about 39% or about 50% are in comparative forms.

An Au-wire was brought into contact with the center of the external electrode of each of the 100 multilayer ceramic capacitors in each of the groups having the different glossiness values, the ultrasonic process was performed for about 5 ms, for example, and after that, the connectivity was evaluated by checking whether the Au-wire and the external electrode are connected to each other.

FIG. 7 is a table indicating evaluation result 2 evaluating the connectivity between the wire and the external electrode in the multilayer ceramic capacitor 1. As indicated in FIG. 7, in the case of the multilayer ceramic capacitors in the comparative form having the glossiness value of about 39% that is smaller than about 63%, the connection failure rate is 15/100. In the case of the multilayer ceramic capacitors in the comparative form having the glossiness value of about 50% that is smaller than about 63%, the connection failure rate is 9/100. In contrast, in the case of the multilayer ceramic capacitors 1 according to the present example embodiment having the glossiness value of about 63%, the connection failure rate is 2/100. Furthermore, in the case of the multilayer ceramic capacitors 1 according to the present example embodiment having the glossiness value of about 71% or about 79%, the connection failure rate is 0/100. That is, it has been confirmed that all the multilayer ceramic capacitors were successfully connected.

Furthermore, reduction of the linearity of the primary electrode layer 3a is related to an increase in the glossiness of the Au-plated layer 3b2 formed on the outermost surface. For example, the linearity of the primary electrode layer 3a is about 1.21 and the glossiness of the Au-plated layer 3b2 formed on the outermost surface is about 66%. The linearity of the primary electrode layer 3a is about 1.11 and the glossiness of the Au-plated layer 3b2 formed on the outermost surface is about 77%, for example.

That is, in the case where the linearity of the primary electrode layer 3a is about 1.21 or smaller, for example, which is within the range of the multilayer ceramic capacitor 1 according to the present example embodiment, the recognition failure rate is 0/100 and the connection failure rate is 2/100 or smaller. In the case where the linearity of the primary electrode layer 3a is about 1.11 or smaller, for example, which is within the more preferable range of the multilayer ceramic capacitor 1 according to the present example embodiment, the recognition failure rate is 0/100 and the connection failure rate is 0/100 or smaller.

Accordingly, from the viewpoints of the linearity of the primary electrode layer 3a, favorable results can be obtained in the recognition property and the connectivity of the multilayer ceramic capacitor 1 according to the present example embodiment.

In the multilayer ceramic capacitor 1 according to the present example embodiment, the dimension is larger in the lamination direction T than in the first direction L and the second direction W. As illustrated in FIG. 2, the multilayer ceramic capacitor 1 is joined to the first land 101 provided on the one surface of the substrate 100 with, for example, the solder 102. The second external electrode 32 on the fourth surface F4 side is joined to the first land 101 with solder the 102. However, the multilayer ceramic capacitor 1 is not limited to this.

FIG. 8 illustrates a state in which a multilayer ceramic capacitor 1A according to another example embodiment of the present invention is mounted on the substrate 100. In the multilayer ceramic capacitor 1A, the dimension may be smaller in the lamination direction T than in the first direction L in which the external electrodes 3 are formed at each end as illustrated in FIG. 8 and the second direction W, which is not illustrated.

The external electrodes 3 extend to the first surface F1, the second surface F2, the fifth surface F5, and the sixth surface F6 more in the multilayer ceramic capacitor 1A according to the other example embodiment than in the multilayer ceramic capacitor 1 according to the above-described example embodiment.

The other configurations of the multilayer ceramic capacitor 1A are similar to those of the multilayer ceramic capacitor 1 according to the above-described example embodiments. Thus, description of the similar portions is omitted. That is, the external electrodes 31 and 32 of the multilayer ceramic capacitor 1A each include the primary electrode layer and the plated layer. The glossiness of the outermost surface of the plated layer is about 63% or greater, and preferably, about 71% or greater, for example. The linearity of the primary electrode layer is about 1.21 or smaller, and preferably, about 1.11 or smaller, for example.

The second surface F2 of the multilayer ceramic capacitor 1A according to the other example embodiment is joined to the first land 101 provided on the one surface of the substrate 100 with, for example, epoxy resin 105. The wires 202 extend from both of the external electrode 31 and the external electrode 32 extending to the first surface F1 side.

Also with the multilayer ceramic capacitor 1A according to the other example embodiment, as is the case with the multilayer ceramic capacitor 1 according to the present example embodiment, favorable results can be obtained in the recognition property and the connectivity during the wire bonding.

Although example embodiments according to the present invention have been described, the present invention is not limited to the example embodiments described above and can be subjected to various changes and modifications as follows.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer electronic component comprising:
a laminate including:
a first surface and a second surface opposite to each other in a lamination direction;
a third surface and a fourth surface opposite to each other in a first direction intersecting the lamination direction; and
a fifth surface and a sixth surface opposite to each other in a second direction intersecting the lamination direction and the first direction; and
external electrodes respectively provided on the third surface and the fourth surface of the laminate; wherein
the external electrodes include a primary electrode layer and a plated layer; and
glossiness of an outermost surface of the plated layer is about 63% or greater.

2. The multilayer electronic component according to claim 1, wherein the external electrodes are also provided on the first surface, the second surface, the fifth surface, and the sixth surface.

3. The multilayer electronic component according to claim 1, wherein the glossiness of the outermost surface of the plated layer is about 71% or greater.

4. The multilayer electronic component according to claim 1, wherein linearity of the primary electrode layer is about 1.21 or smaller.

5. The multilayer electronic component according to claim 1, wherein linearity of the primary electrode layer is about 1.11 or smaller.

6. The multilayer electronic component according to claim 1, wherein the plated layer includes an Au-plated layer at the outermost surface.

7. The multilayer electronic component according to claim 1, wherein the primary electrode layer includes a glass component and Cu.

8. The multilayer electronic component according to claim 1, wherein the primary electrode layer includes a dielectric component and Ni.

9. The multilayer electronic component according to claim 1, wherein the glossiness of the outermost surface of the plated layer is about 79% or greater.

10. The multilayer electronic component according to claim 1, wherein the glossiness of the outermost surface of the plated layer is about 79% or greater and linearity of the primary electrode layer is about 1.21 or smaller.

11. The multilayer electronic component according to claim 1, wherein the glossiness of the outermost surface of the plated layer is about 79% or greater and linearity of the primary electrode layer is about 1.11 or smaller.

12. The multilayer electronic component according to claim 1, wherein the glossiness of the outermost surface of the plated layer is about 71% or greater and linearity of the primary electrode layer is about 1.21 or smaller.

13. The multilayer electronic component according to claim 1, wherein the glossiness of the outermost surface of the plated layer is about 71% or greater and linearity of the primary electrode layer is about 1.11 or smaller.

14. A multilayer electronic component comprising:
a laminate including:
a first surface and a second surface opposite to each other in a lamination direction;
a third surface and a fourth surface opposite to each other in a first direction intersecting the lamination direction; and
a fifth surface and a sixth surface opposite to each other in a second direction intersecting the lamination direction and the first direction; and
external electrodes respectively provided on the third surface and the fourth surface of the laminate; wherein
the external electrodes include a primary electrode layer and a plated layer; and
linearity of the primary electrode layer is about 1.21 or smaller.

15. The multilayer electronic component according to claim 14, wherein linearity of the primary electrode layer is about 1.11 or smaller.

16. The multilayer electronic component according to claim 14, wherein the plated layer includes an Au-plated layer at the outermost surface.

17. The multilayer electronic component according to claim 14, wherein the primary electrode layer includes a glass component and Cu.

18. The multilayer electronic component according to claim 14, wherein the primary electrode layer includes a dielectric component and Ni.

19. The multilayer electronic component according to claim 14, wherein the external electrodes are also provided on the first surface, the second surface, the fifth surface, and the sixth surface.
